(19) United States
(12) Patent Application Publication
(10) Pub. No.: US 2021/0071630 A1
(43) Pub. Date: Mar. 11, 2021

(54) COMBUSTION ENGINE STARTER SYSTEMS AND METHODS

(71) Applicant: Ford Global Technologies, LLC, Dearborn, MI (US)

(72) Inventors: Rian EDMAN, Dearborn, MI (US); Thomas CICCONE, West Bloomfield, MI (US); Timothy BAXENDALE, Royal Oak, MI (US)

(21) Appl. No.: 16/566,993

(22) Filed: Sep. 11, 2019

(51) Int. Cl. F02N 11/08; F02N 11/04

(52) U.S. Cl. CPC F02N 11/0866; F02N 11/04; F02N 2011/0888; F02N 2300/2002; F02N 2200/046; F02N 2200/063; F02N 2011/0896

(57) ABSTRACT

A vehicle includes a combustion engine configured to crank start via torque applied to a crankshaft. The vehicle also includes a first electric machine to drive vehicle wheels powered by a high-voltage power source and coupled to the crankshaft and a second electric machine powered by a low-voltage power source and coupled to the crankshaft. The vehicle further includes a controller programmed to monitor a battery state of charge (SOC) and a voltage of the high-voltage power source. The controller is also programmed to activate only the second electric machine to attempt to crank start the engine in response to either of the SOC or the voltage being less than a predetermined threshold, and activate the first electric machine to attempt to crank start the engine in response to each of the SOC and the voltage being greater than a predetermined threshold.

### TECHNICAL FIELD

This application is related to maintaining a vehicle battery over an extending storage period.

### BACKGROUND

Vehicles having electrified propulsion systems may include a rechargeable high-voltage battery to provide power to one or more electric machines as well as other vehicle systems. Over time battery power may become depleted even when unused, such as during periods of extended duration vehicle storage.

### SUMMARY

A vehicle includes a combustion engine configured to crank start via torque applied to a crankshaft. The vehicle also includes a first electric machine to drive vehicle wheels powered by a high-voltage power source and coupled to the crankshaft and a second electric machine powered by a low-voltage power source and coupled to the crankshaft. The vehicle also includes a controller programmed to monitor a battery state of charge (SOC) and a voltage of the high-voltage power source. The controller is also programmed to activate the first electric machine to attempt to cold crank start the engine in response to an engine start request and each of the SOC and the voltage being greater than respective SOC and voltage thresholds. The controller is also programmed to activate the second electric machine to provide supplemental torque to assist the first electric machine in the attempt to cold crank start the engine in response to a slowing of engine rotation being greater than a slowing threshold during the crank start of the engine by the first electric machine. The controller is further programmed to inhibit the first electric machine but not the second electric machine from attempting to crank start the engine in response to an unsuccessful engine crank start attempt by a combined activation of both the first electric machine and the second electric machine.

A method of arbitrating between multiple crank start sources for a combustion engine includes monitoring a battery SOC and a voltage of a high-voltage power source configured to power a first electric machine. The method also includes activating the first electric machine to cold crank start the engine in response to each of the SOC and the voltage being greater than a predetermined threshold. The method further includes activating a second electric machine powered by a low-voltage power source to provide supplemental torque to crank start the engine in response to a slowing of engine rotational being greater than a slowing threshold during the crank start of the engine by the first electric machine. The method further includes inhibiting the first machine but not the second electric machine from attempting to crank start the engine in response to an unsuccessful engine crank start attempt by the combined activation of both the first electric machine and the second electric machine.

A vehicle includes a combustion engine configured to crank start via torque applied to a crankshaft. The vehicle also includes a first electric machine to drive vehicle wheels powered by a high-voltage power source and coupled to the crankshaft and a second electric machine powered by a low-voltage power source and coupled to the crankshaft. The vehicle further includes a controller programmed to monitor a battery state of charge (SOC) and a voltage of the high-voltage power source. The controller is also programmed to activate only the second electric machine to attempt to crank start the engine in response to either of the SOC or the voltage being less than a predetermined threshold, and activate the first electric machine to attempt to crank start the engine in response to each of the SOC and the voltage being greater than a predetermined threshold.

### BRIEF DESCRIPTION OF THE DRAWINGS

FIG. 1 is a schematic of a vehicle having an electrified propulsion system.

FIG. 2 is a flowchart of a first method of arbitrating between multiple engine cranking sources.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Efficacy of power exchange with a vehicle battery is influences by several key inputs such as battery temperature, unused time in storage, competing electrical loads, etc. When a hybrid electric vehicle (HEV) vehicle is not driven for an extended period of time, the state of charge (SOC) of the high-voltage and/or low-voltage batteries depletes. At the same time, this loss of charge is exaggerated by cold or low ambient temperatures. Moreover, an HEV that relies on the high-voltage battery to start the internal combustion engine may become inoperable after the high-voltage battery SOC has depleted to less than a threshold level. The high-voltage battery can only be charged by driving the vehicle and there is no convenient way for the customer to “jumpstart” an HEV high-voltage system. The result may be a need for the vehicle to be towed to a dealership for service, causing customer dissatisfaction, cost, and loss of time. Thus, when the capacity of any of the starting systems is reduced, the control systems and methods of the present disclosure recognize the deficiency and arbitrate torque between multiple sources according to the conditions in order to provide the best chance of starting in spite of limited capability.

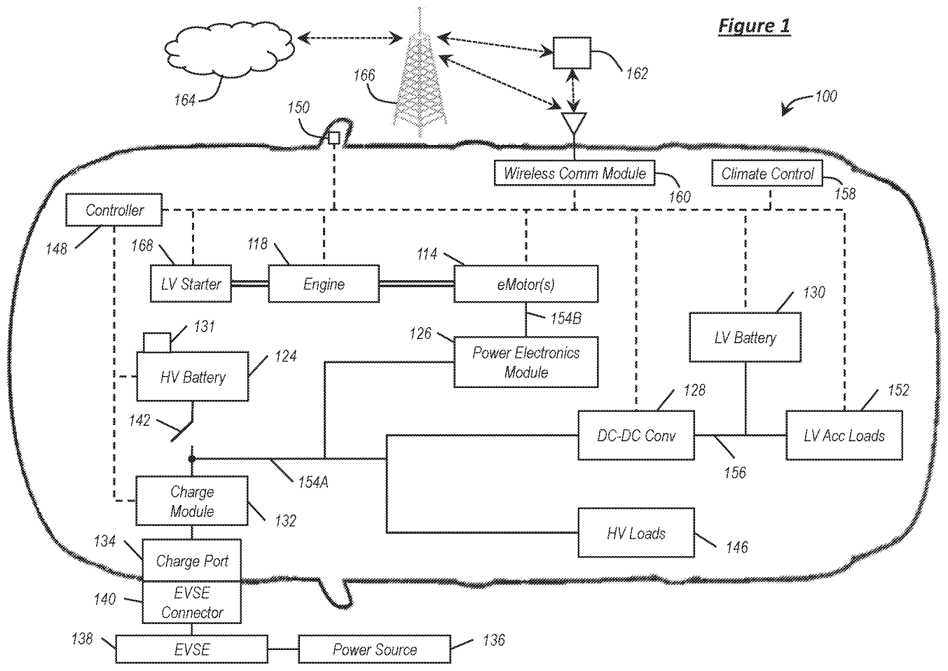

FIG. 1 depicts a plug-in hybrid-electric vehicle (PHEV) 100. The PHEV 100 includes an electrified propulsion system having one or more battery-powered electric machines 114 mechanically coupled to a hybrid transmission (not shown). Each of the electric machines 114 may be capable of operating either as a motor or as a generator. In addition, the electric machines 114 are mechanically coupled to an internal combustion engine 118. When operated, the engine 118 is configured to output torque. The electric machines 114 are arranged to provide propulsion torque as well as slowing torque capability either while the engine 118 is operated or turned off. The electric machines 114 are also capable of operating as generators to provide fuel economy benefits by recovering energy that would normally be lost as heat in a friction braking system. The electric machines 114 may additionally impart a reaction torque against the engine output torque to generate electricity for recharging a traction battery the while the engine 118 is operating. The electric machines 114 may further reduce vehicle emissions by allowing the engine 118 to operate near the most efficient speed and torque ranges. When the engine 118 is off, the PHEV 100 may be operated in an electric-only drive mode using the electric machines 114 as the sole source of propulsion.

The hybrid transmission is also mechanically coupled to road wheels to output torque from the electric machines 114 and/or combustion engine 118. While the topology of hybrid vehicle 100 is provided by way of example, aspects of the present disclosure may be applicable to any vehicle having a hybrid-electric propulsion system.

A rechargeable traction battery or battery pack 124 stores energy that can be used to power the electric machines 114. The battery 124 typically provides a high-voltage direct current (DC) output from one or more battery cell arrays, sometimes referred to as battery cell stacks, within the traction battery 124. Each battery cell array may include one or more battery cells. The battery cells, such as a prismatic, pouch, cylindrical, or other types of cells, are used to convert stored chemical energy to electrical energy. The cells may include a housing, a positive electrode (cathode) and a negative electrode (anode). An electrolyte allows ions to move between an anode and cathode during discharge, and then return during recharge. Terminals may allow current to flow out of the cell for use by the vehicle. Different battery pack configurations may be available to address individual vehicle variables including packaging constraints and power requirements. Discussed in more detail below, the battery cells may be thermally regulated by a thermal-management system. Examples of thermal-management systems include air cooling systems, liquid cooling systems and a combination of air and liquid systems.

One or more contactors 142 may selectively isolate the traction battery 124 from a DC high-voltage bus 154A when opened and couple the traction battery 124 to the DC high-voltage bus 154A when closed. In some examples, detection of a fault condition causes the contactors 142 to open thereby disabling power delivery from the high-voltage traction battery 124. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. The traction battery 124 may provide a DC current while the electric machines 114 operate using a three-phase alternating current (AC). The power electronics module 126 may convert the DC current to a three-phase AC current to operate the electric machines 114. According to some examples, high-voltage corresponds to the electric machine 114 being powered at about 48 V or greater. According to further examples, high-voltage corresponds to the electric machine 114 being powered at about 300 V. In a regenerative mode, the power electronics module 126 may convert the three-phase AC current output from the electric machines 114 acting as generators to DC current compatible with the traction battery 124. The description herein is equally applicable to an all-electric vehicle without a combustion engine.

In addition to providing energy for propulsion, the traction battery 124 may provide energy for other vehicle electrical systems. The vehicle 100 may include a DC/DC converter module 128 that is electrically coupled to the high-voltage bus 154. The DC/DC converter module 128 may be electrically coupled to a low-voltage bus 156. The DC/DC converter module 128 may convert the high-voltage DC output of the traction battery 124 to a low-voltage DC supply that is compatible with low-voltage vehicle accessory loads 152. The low-voltage bus 156 may also be electrically coupled to an auxiliary battery 130 (e.g., a 12-volt battery). The low-voltage vehicle accessory loads 152 may be electrically connected to one or more power sources over the low-voltage bus 156. The low-voltage vehicle accessory loads 152 may also include various controllers within the vehicle 100 governing a number of vehicle accessory features.

In some examples, such as a PHEV, the traction battery 124 of vehicle 100 may be recharged by an off-board power source 136. The off-board power source 136 may be a connection to an electrical outlet. The external power source 136 may be electrically coupled to a charging station or another type of electric vehicle supply equipment (EVSE) 138. The off-board power source 136 may also be an electrical power distribution network or grid as provided by an electric utility company. The EVSE 138 provides circuitry and controls to regulate and manage the transfer of energy between the power source 136 and the vehicle 100. The off-board power source 136 may provide DC or AC electric power to the EVSE 138.

The EVSE 138 includes a charge connector 140 for plugging into a charge port 134 of the vehicle 100. The charge port 134 may be any type of port configured to transfer power from the EVSE 138 to the vehicle 100. The charge port 134 may be electrically coupled to a charge module or on-board power conversion module 132. The power conversion module 132 conditions power supplied from the EVSE 138 to provide the proper voltage and current levels to the traction battery 124. The power conversion module 132 interfaces with the EVSE 138 to coordinate the delivery of power to the vehicle 100. The EVSE connector 140 may have pins that mate with corresponding recesses of the charge port 134. Alternatively, various components described as being electrically coupled or connected may transfer power using wireless inductive coupling or other non-contact power transfer mechanisms. The charge components including the charge port 134, power conversion module 132, power electronics module 126, and DC-DC converter module 128 may collectively be considered part of a power interface system configured to receive power from the off-board power source 136.

When the vehicle 100 is plugged in to the EVSE 138, the contactors 142 may be in a closed state so that the traction battery 124 is coupled to the high-voltage bus 154 and to the power source 136 to charge the battery. The vehicle may be in the ignition-off condition when plugged in to the EVSE 138. Of course, when the vehicle is stored at a location where plug-in charging is unavailable, both the high-voltage traction battery 124 and low-voltage auxiliary battery 130 may be subject to SOC depletion and discharge capacity degradation effects

The traction battery 124 may also have one or more temperature sensors 131 such as thermistors or other types of temperature sensors. The temperature sensor 131 may be in communication with the controller 148 to provide data indicative of temperature of the battery cells. The vehicle 100 may also include temperature sensor 150 to provide data indicative of ambient air temperature. In the example schematic of FIG. 1, the temperature sensor 150 is disposed in a vehicle side mirror, but it should be appreciated that the temperature sensor may be located anywhere on the vehicle suitable to detect ambient temperature.

One or more high-voltage electrical loads 146 may be coupled to the high-voltage bus 154. The high-voltage electrical loads 146 may have an associated controller that operates and controls the high-voltage electrical loads 146 when appropriate. The high-voltage loads 146 may include compressors and electric heaters related to the vehicle climate control system 158. For example, the vehicle climate control system may draw high-voltage loads in the range of 6 kW-11 kW under high cooling loads. According to some examples, the rechargeable battery 124 supplies powers at least a portion of the climate control system 158.

The vehicle 100 further includes at least one wireless communication module 160 configured to communicate with external devices. over a wireless network. According to some examples, wireless communication module includes a BLUETOOTH transceiver to communicate with a user's remote device 162 (e.g., cell phone, smart phone, PDA, or any other device having wireless remote network connectivity). The remote device 162 can in turn be used to communicate with a network 164 outside the vehicle 100 through, for example, communication with a cellular tower 166. In some examples, tower 166 may be a WiFi access point.

Data may be communicated between the wireless communication module 160 and a remote network utilizing, for example, a data-plan, data over voice, or DTMF tones associated with the remote device 162. Alternatively, the wireless communication module 160 may include an onboard modem having antenna in order to exchange data with the network 164 over the voice band. According to some examples, the controller 148 is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In further example, remote device 162 includes a modem for voice band or broadband data communication. In the data-over-voice example, a technique known as frequency division multiplexing may be implemented when the owner of the nomadic device can talk over the device while data is being transferred. At other times, when the owner is not using the device, the data transfer can utilize the entire bandwidth. Further data transfer protocols may also be suitable according to aspects of the present disclosure, for example, such as Code Domain Multiple Access (CDMA), Time Domain Multiple Access (TDMA), and Space-Domain Multiple Access (SDMA) for digital cellular communication.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 148 may be provided to coordinate the operation of the various components.

System controller 148, although represented as a single controller, may be implemented as one or more controllers. The controller 148 may monitor operating conditions of various vehicle systems. According to the example of FIG. 1, at least the high-voltage electric machine 114, engine 118, traction battery 124, auxiliary battery 130, DC-DC converter 128, charging module 132, high-voltage loads 146, low-voltage loads 152, and low-voltage starter motor 168 are in communication with the controller 148.

The controller 148 also generally includes any number of subcomponents such as microprocessors, ASICs, ICs, memory (e.g., FLASH, ROM, RAM, EPROM and/or EEPROM) and software code to co-act with one another to perform various operations. The subcomponents allow onboard processing of commands and execute any number of predetermined routines according to a desired timing or alternatively in response to one or more inputs received from vehicle systems. The processors may be coupled to non-persistent storage and/or persistent storage. In an example configuration, the non-persistent storage is RAM, and the persistent storage is flash memory. In general, persistent (non-transitory) storage can include all forms of storage that maintain data when a computer or other device is powered down. The controller 148 may also store predetermined data within the memory, such as “look up tables” that are based on calculations and/or test data. The controller communicates with other vehicle systems and sub-controllers over one or more wired or wireless vehicle connections and may use common bus protocols (e.g., CAN and LIN). Used herein, references to “a controller” refer to one or more controllers.

The traction battery 124 includes a current sensor to output a signal indicative of a magnitude and direction of current flowing into or out of the traction battery 124. The traction battery 124 also includes a voltage sensor to sense a voltage across terminals of the traction battery 124. The voltage sensor outputs a signal indicative of the voltage across the terminals of the traction battery 124. The traction battery 124 may also have one or more temperature sensors 131 such as thermistors or other types of temperature sensors. The temperature sensor 131 may be in communication with the controller 148 to provide data indicative of temperature of the battery cells.

The current sensor, voltage sensor, and temperature sensor outputs of the traction battery 124 are all provided to the controller 148. The controller 148 may be programmed to compute the battery's SOC based on the signals from the current sensor and the voltage sensor of the traction battery 124. Various techniques may be utilized to compute the state of charge. For example, an ampere-hour integration may be implemented in which the current through the traction battery 124 is integrated over time. The SOC may also be estimated based on the output of the voltage sensor of the traction battery. The specific technique utilized may depend upon the chemical composition and characteristics of the particular battery.

The vehicle also includes a second electric machine, or starter motor 168 that is powered over the low-voltage bus 156. According to some examples, low-voltage corresponds to the starter motor 168 being powered at about 12 V to 14 V or less. The starter motor 168 may be coupled to a crankshaft of the engine 118 and when activated impart torque on the crankshaft. According to further examples, the starter motor is coupled to a flywheel of the engine via a belt, where operation of the flywheel turns the crankshaft. Once sufficient rotational speed sufficient speed to support combustion is achieved by the engine 118, further continuous operation of the engine may be maintained without further assistance by the starter motor 168.

The low-voltage starter motor 168 has similar limitations regarding power output. That is, certain aspects of performance may be degraded at low ambient temperature. For example, where the low-voltage starter motor 168 is coupled to the engine via a belt, torque transfer may be reduced due to belt slip when condensation freezes on the surface of the belt. In other cases, low temperature conditions and/or long-term storage may degrade the power output capability of the low-voltage battery 130.

As described above, the electric machine 114 is also mechanically coupled to the engine 118. And, similar to the starter motor 118, the electric machine 114 may apply torque to the engine 118 to support engine cranking on startup. However, the electric machine 114 is electrically powered by the high-voltage battery 131 as opposed to the low-voltage battery 130. Each of the high-voltage electric machine and the and low-voltage starter motor 168 can be used to crank the engine 118 to initiate combustion.

Having multiple energy sources available to start the engine 118 provides a unique advantage to a hybrid powertrain. The high-voltage electric machine 114 has great capability to crank the engine when adequate power is available. The electric machine 114 provides a comparable performance to the starter motor 168 but may provide improved performance with respect to outputting less noise, vibration, and harshness when cranking the engine. However, there may be certain scenarios where the necessary power is not available and the high-voltage electric machine 114 cannot reliably be used as the primary device for cranking the engine 118.

In the case of a cold crank start, the engine requires cranking from a cold state relative to its normal operating temperature. A cold crank start can be due to cold weather conditions, since most climates will naturally be at a lower ambient temperature relative to a typical operating temperature of an engine. Cold crank start may also refer to starting the engine after a vehicle has been inactive or stored for a significant amount of time. Cold crank starts may be more difficult than starting a vehicle that has been run recently, requiring more cranking torque to turn over the crankshaft of a cold engine. Specifically, the engine compression may be higher as the lack of heat makes ignition more difficult. Additionally, lower temperatures may cause engine oil to become more viscous, contributing to increased resistance. Further, at cooler temperatures air becomes denser affecting the air-fuel ratio, which in turn can impact the flammability of the air-fuel mixture. Discussed in more detail below, the controller may be programmed to arbitrate between engine cranking sources based on vehicle conditions to improve performance under cold crank starting conditions.

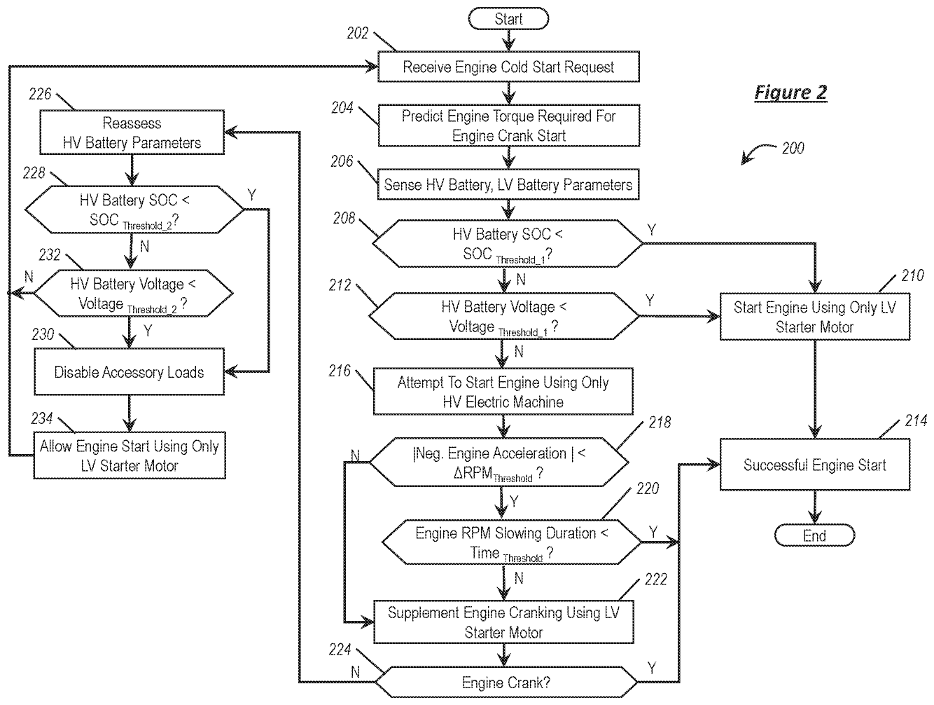

Referring to FIG. 2, method 200 represents an algorithm to arbitrate between engine cranking sources based on vehicle conditions. At step 202 the algorithm includes receiving an engine cold start request. The request may be as a result of a user operation of an ignition switch. In other examples, a remote start may have been requested, for example via a remote device. In further examples, the controller may be programmed to periodically start the vehicle while in storage to maintain health of one or more vehicle batteries by providing recharging from engine output while idling.

At step 204 the algorithm includes predicting the torque required to crank the engine. The engine cranking torque may vary based on changes in mechanical friction of the cranking components. The cranking torque friction may vary at least based on oil temperature, coolant temperature, and/or ambient temperature. And the cranking torque friction may be characterized by a predetermined torque model for a given engine.

At step 206 the algorithm includes sensing any of a number of battery parameters that may influence the cranking power available from the electric machine as powered by the high-voltage battery. Based on the power capacity available in the high-voltage battery, the algorithm includes determining the torque available to crank the engine using the high-voltage electric machine at any given rotational speed. According to some examples, the algorithm includes selection of the optimal cranking speed. According to further examples, a similar power capacity calculation may be performed for the low-voltage battery and starter motor.

Based on the above steps, the controller is capable of calculating prior to a start attempt how much torque is required to successfully crank the engine and how much torque is available from each of the engine cranking sources. The maximum discharge power of each of the high-voltage battery and low-voltage battery may vary as a function of the respective measurable battery SOC and battery voltage.

If at step 208 the high-voltage battery SOC is less than a predetermined SOC_{Threshold_1}, the algorithm includes at step 210 attempting to start the engine using only the low-voltage starter motor. As described above, the controller may store a variable charge threshold that is adjusted based on any number of parameters, including at least one of oil temperature, coolant temperature, and/or ambient temperature.

If at step 208 the high-voltage battery SOC is greater than or equal to the predetermined SOC_{Threshold_1}, the algorithm includes at step 212 assessing the high-voltage battery voltage. If at step 212 the high-voltage battery voltage is less than a predetermined Voltage_{Threshold_1}, the algorithm avoids using the high-voltage electric machine and instead at step 210 attempts to start the engine using only the low-voltage starter motor. Much like above, the controller may store lookup tables and/or calculation subroutines to determine Voltage_{Threshold_1} based on present vehicle conditions.

At step 214 as a result of a successful engine start, the algorithm for arbitrating between available engine cranking sources may conclude.

If at step 212, the high-voltage battery voltage is greater than or equal to Voltage_{Threshold_1}, the algorithm includes at step 216 attempting to start the engine using only the high-voltage electric machine as powered by the high-voltage battery.

The algorithm of method 200 further includes an engine stall detection subroutine. In some cases, such as due to high cranking torque friction resistance, the high-voltage electric machine may not be able to sustain sufficient impeller speed to hold a locked state for a clutch coupling the engine to the high-voltage electric machine. The clutch may therefore enter a slip state causing engine speed to start to decrease. If the magnitude of a negative engine rotational acceleration rate exceeds a calibratable threshold for a predetermined amount of time, the engine is deemed to have entered a stall condition. At step 218 the algorithm includes assessing the presence and degree of engine rotational slowing.

If at step 218 the absolute value of the measured engine slowing is less than a predetermined ΔRPM_{Threshold}, the algorithm includes a determination that no engine stall has occurred.

If at step 218 the absolute value of the measured engine slowing is greater than or equal to the predetermined ΔRPM_{Threshold}, the algorithm includes quantifying the duration of the engine slowing during the cranking event. If at step 220 the engine slowing duration is less than a predetermined Time_{Threshold}, the slowing may not be deemed a stall condition related to a shorter slowing duration. At step 214 algorithm includes concluding that there has been a successful engine start, and arbitration between available engine cranking sources concludes

If at step 220 the slowing of engine rotation has a duration is greater than or equal to the predetermined Time_{Threshold}, the algorithm includes making a determination that there is an engine stall condition. In the event that an engine stall condition is detected, the low-voltage starter motor is requested to assist in accelerating the engine up to a steady state speed where combustion can be initiated. In some examples, the controller may be programmed to activate the low-voltage starter motor to provide supplemental torque to assist the high-voltage electric machine in the attempt to cold crank start the engine in response to the slowing of engine rotation having a duration longer than a time threshold.

At step 222 the algorithm includes activating the low-voltage starter motor to supplement the cranking torque applied by the high-voltage electric machine.

If at step 224 the engine cranks (i.e., turns over), a successful engine start event at step 214 may conclude the arbitration between available engine cranking sources.

If at step 224 the attempt to engine crank start the engine using the low-voltage starter motor to supplement the high-voltage electric machine is unsuccessful, the algorithm includes at step 226 reassessing the voltage and SOC of the high-voltage battery pack. If the pack voltage or SOC are within a calibratable threshold of the conditions where the high-voltage contactors will open and fully disable the vehicle, the algorithm includes countermeasures to avoid stranding the user with an inoperable vehicle. Thus, the algorithm includes not attempting further high-voltage crank attempts and entering a service cranking mode subroutine.

If at step 228 the high-voltage battery SOC is less than a predetermined SOC_{Threshold_2} which would trigger a fault condition and cause at least one of the high-voltage battery contactors to open, the algorithm includes at step 230 disabling vehicle accessory loads that pull power from the low-voltage battery.

If at step 228 the high-voltage battery SOC is greater than or equal to the predetermined SOC_{Threshold_2}, the algorithm includes at step 232 assessing the high-voltage battery voltage. If at step 232 the high-voltage battery voltage is less than a predetermined Voltage_{Threshold_2} which would trigger a fault condition and cause at least one of the high-voltage battery contactors to open, the algorithm includes at step 230 disabling vehicle accessory loads that draw power from the low-voltage battery. Much like the above examples, the controller may store lookup tables and/or calculation subroutines to determine each of SOC_{Threshold_2} and Voltage_{Threshold_2} real-time based on present vehicle conditions.

If the high-voltage battery is within the threshold of the voltage or the SOC to open at least one contactor, the algorithm includes a service mode subroutine that will disable vehicle accessory loads and revert to attempting only low-voltage engine cranks. This service mode maintains the ability of the customer or vehicle service personnel to connect a portable jump pack to a more readily accessible low-voltage battery and continue trying to start the engine, such as via a jumpstart. In contrast, full system capability may be lost due to the high-voltage battery contactors being opened. On many hybrids, the connector for the high-voltage battery pack is not readily accessible and is thus a more expensive and difficult service task if reconnection is required.

At step 234 the engine starts using the high-voltage battery is disabled, and only the low-voltage battery is allowed for starts to facilitate the service mode. The algorithm returns to step 202 to monitor for further engine start requests such as a cranking request related to a jumpstart.

The above systems and methodologies make it easier for the customer to store the vehicle over a season, before a trip, or even overnight and maintain confidence that it will start reliably when they return, especially in cold weather and near the end of the vehicle's life. Engine non-starts may cause the customer to be stranded and/or require towing to a service location. As the vehicle and high-voltage battery age, the battery's power capability decreases. The systems and methods of the present disclosure help ensure the customer is not more likely to be stranded as their vehicle ages. As such, the algorithms of the present disclosure are self-adjusting according to the real-time conditions of the battery and auto-start more or less frequently based on the age of the vehicle. Moreover, since cold temperatures are a strong contributor to cause a high-voltage battery's SOC to degrade, an inoperable vehicle in such conditions is even more inconvenient than in warm conditions. By utilizing the systems and methods described herein, weaknesses associated with electrical power retention during extended storage are offset and the vehicle can remain stored, yet fully operational, for extremely long periods of time.

While several of the examples above describe the high-voltage electric machine being supplemented by the low-voltage starter motor to crank start the engine under certain conditions, it should be appreciated that the opposite configuration may also be useful. That is, the low-voltage electric machine may similarly be supplemented by the high-voltage starter motor for engine crank starting in cases where the low-voltage starter motor is under less than optimal electrical output conditions that may result in unsuccessful engine start attempts.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle comprising:
a combustion engine configured to crank start via torque applied to a crankshaft;
a first electric machine to drive vehicle wheels powered by a high-voltage power source and coupled to the crankshaft;
a second electric machine powered by a low-voltage power source and coupled to the crankshaft; and
a controller programmed to,
in response to an engine start request and each of a state of charge (SOC) and voltage of a high-voltage power source being greater than respective SOC and voltage thresholds, activate the first electric machine to attempt to cold crank start the engine,
in response to a slowing of engine rotation being greater than a slowing threshold during the crank start of the engine by the first electric machine, activate the second electric machine to provide supplemental torque to assist the first electric machine in the attempt to cold crank start the engine such that the first electric machine and second electric machine are cranking the engine at a same time, and
in response to an unsuccessful engine crank start attempt by a-combined activation of both the first electric machine and the second electric machine, inhibit the first electric machine but not the second electric machine from attempting to crank start the engine.

2. The vehicle of claim 1 wherein the controller is further programmed to activate the second electric machine to provide supplemental torque to assist the first electric machine in the attempt to cold crank start the engine in response to the slowing of engine rotation having a duration longer than a time threshold.

3. The vehicle of claim 2 further comprising a contactor configured to electrically decouple the high-voltage power source in response to a fault condition wherein the first electric machine is inhibited from crank starting prior to the contactor decoupling the high-voltage power source.

4. The vehicle of claim 1 wherein the controller is further programmed to disable vehicle accessory loads in response to an unsuccessful engine crank start attempt by both the first electric machine and the second electric machine.

5. The vehicle of claim 1 wherein the controller is further programmed to detect an unsuccessful engine crank start attempt based on slowing of engine rotational speed exceeding a threshold.

6. The vehicle of claim 1 wherein each of the respective SOC and voltage thresholds is based on a predicted required engine cranking torque.

7. The vehicle of claim 1 wherein each of the respective SOC and voltage thresholds is based at least on one of an oil temperature, a coolant temperature, and an ambient air temperature.

8. A method of arbitrating between multiple crank start sources for a combustion engine comprising:
activating a first electric machine to cold crank start the engine in response to each of a state of charge (SOC) and voltage of a high-voltage power source being greater than respective SOC and voltage thresholds;
activating a second electric machine powered by a low-voltage power source to provide supplemental torque to crank start the engine in response to a slowing of engine rotational speed being greater than a slowing threshold during the crank start of the engine by the first electric machine such that the first electric machine and second electric machine are cranking the engine at a same time;
inhibiting the first electric machine but not the second electric machine from attempting to crank start the engine in response to an unsuccessful engine crank start attempt by a combined concurrent activation of both the first electric machine and the second electric machine; and
adjusting the respective SOC and voltage thresholds based at least on one of an oil temperature, a coolant temperature, and an ambient temperature.

9. The method of claim 8 wherein the high-voltage power source includes a contactor configured to electrically decouple the high-voltage power source in response to a fault condition, and wherein inhibiting the first electric machine is prior to the contactor decoupling the high-voltage power source.

10. The method of claim 8 further comprising disabling vehicle accessory loads in response to an unsuccessful engine crank start attempt by both the first electric machine and the second electric machine.

11. The method of claim 8 further comprising activating the second electric machine to provide supplemental torque to assist the first electric machine in the attempt to cold crank start the engine in response to the slowing of engine rotation having a duration longer than a time threshold.

12. The method of claim 8 wherein the predetermined threshold for each of the SOC and the voltage is based on a predicted required engine cranking torque.

13. (canceled)

14. A vehicle comprising:
a combustion engine configured to crank start via torque applied to a crankshaft;
a first electric machine to drive vehicle wheels powered by a high-voltage power source and coupled to the crankshaft;
a second electric machine powered by a low-voltage power source and coupled to the crankshaft; and
a controller programmed to,
in response to either of a state of charge (SOC) or voltage of the high-voltage power source being less than a predetermined threshold, activate only the second electric machine to attempt to crank start the engine, and
in response to each of the SOC and the voltage being greater than a predetermined threshold, activate the first electric machine to attempt to crank start the engine, and in response to deceleration of a rotational speed of the engine exceeding a deceleration threshold, activate the second electric machine to provide supplemental torque to crank start the engine such that the first electric machine and second electric machine are cranking the engine at a same time.

15. (canceled)

16. The vehicle of claim 14 wherein the controller is further programmed to inhibit the first electric machine from crank starting the engine in response to an unsuccessful attempt to crank start the engine by a-combined activation of both the first electric machine and the second electric machine.

17. The vehicle of claim 14 further comprising at least one contactor configured to electrically decouple the high-voltage power source in response to a fault condition wherein the first electric machine is inhibited from attempting to crank start prior to the at least one contactor decoupling the high-voltage power source.

18. The vehicle of claim 14 wherein the controller is further programmed to disable vehicle accessory loads in response to an unsuccessful attempt to crank start the engine by both the first electric machine and the second electric machine.

19. (canceled)

20. The vehicle of claim 14 wherein the predetermined threshold for each of the SOC and the voltage is based at least on one of an oil temperature, a coolant temperature, and an ambient air temperature.
